(19) United States
(12) Patent Application Publication
(10) Pub. No.: US 2024/0177470 A1
(43) Pub. Date: May 30, 2024

(54) MACHINE LEARNING SYSTEMS AND METHODS FOR GENERATING STRUCTURAL REPRESENTATIONS OF PLANTS

(71) Applicant: Terramera, Inc., Vancouver (CA)

(72) Inventors: Darren Bryce SUTTON, Burnaby (CA); Ghassan HAMARNEH, Burnaby (CA); Carolina PARTIDA, Burnaby (CA)

(21) Appl. No.: 18/285,193

(22) PCT Filed: Mar. 29, 2022
(86) PCT No.: PCT/CA2022/050466

§ 371 Date: Sep. 29, 2023

Related U.S. Application Data
(60) Provisional application No. 63/167,873, filed on Mar. 30, 2021.

(51) Int. Cl. G06V 10/82; G06V 10/764; G06V 10/86

(52) U.S. Cl. CPC G06V 10/82; G06V 10/764; G06V 10/86

(57) ABSTRACT

Systems and methods for training a machine learning model for generating a structural representation of a plant are provided, as well as systems and methods for generating a structural representation of a plant via such a model. The training method involves encoding a plant image into a structural representation of the plant (e.g. a “skeleton”), decoding the structural representation of the plant into a reconstructed image of the plant, and classifying the reconstructed image as having been generated based on a ground-truth structural representation or output of the encoder. Such classification incentivizes the encoder to produce structural representations which do not “smuggle” texture information (e.g. appearance, such as color). Texture information may be separately represented. The encoder, once trained, may be used to generate structural representations from plant images without necessarily requiring decoding or classification.

### CROSS-REFERENCE TO RELATED APPLICATIONS

This application claims priority to, and the benefit of, U.S. provisional patent application No. 63/167,873 filed 30 Mar. 2021, the entirety of which is incorporated by reference herein in its entirety.

### TECHNICAL FIELD

The present disclosure relates generally to machine vision, and in particular to systems and methods for characterizing plants in images.

### BACKGROUND

Plants can have diverse and sometimes-complex morphological structures, comprising roots, stems, leaves, reproductive structures, and other elements in a variety of potential configurations. Describing such structures can assist in contexts such as botanical assays, plant-model frameworks such as Functional-Structural Plant Models (FSPM), and plant health or growth models. For instance, plant health may be assessed visually according to plant structure (e.g. wilting, stunting, bolting, leaf curl, asymmetric growth) and/or organ appearance (e.g. lesions, discolouration, venation).

Plant structure is sometimes described by a “skeleton” representation, e.g. as described by Wu et al., An Accurate Skeleton Extraction Approach From 3D Point Clouds of Maize Plants, Front. Plant Sci., 7 Mar. 2019, doi: 10.3389/fpls.2019.00248 via general-purpose skeleton extraction algorithms, such as the medial axis transformation described by Lee, Medial axis transformation of a planar shape, IEEE Transactions on Pattern Analysis and Machine Intelligence, vol. PAMI-4, no. 4, pp. 363-369, July 1982, doi: 10.1109/TPAMI.1982.4767267. Such skeletons describe aspects of an image but may diverge from the plant's morphology, particularly where portions of the plant are occluded (e.g. by overlapping leaves).

Object structure is sometimes describable by machine vision techniques such as image-to-image translation, wherein a machine learning model learns a mapping between image domains. For instance, Jakab et al.; Self-Supervised Learning of Interpretable Keypoints From Unlabelled Videos, Proceedings of the IEEE/CVF Conference on Computer Vision and Pattern Recognition (CVPR), 2020, pp. 8787-8797 describes a method for generating a human skeleton from images of human poses, in part by fitting the skeleton to a tight keypoint bottleneck to enforce a specifically human skeletal morphology. This builds on image-to-image translation models such as CycleGAN, as described by Zhu et al., Unpaired Image-to-Image Translation using Cycle-Consistent Adversarial Networks, arXiv:1703.10593 [cs.CV] and Pix2Pix, as described by Isola et al., Image-to-Image Translation with Conditional Adversarial Networks, arXiv:1611.07004 [cs.CV], which provide models for mapping mostly style information between image domains in a fully supervised context.

Plant structure is often more varied than human morphology, even within a species. Consider a monoculture field of lettuce, for instance. Different heads of lettuce may have different numbers of leaves, resulting in materially dissimilar structure. Moreover, sufficient labelled training data for fully-supervised training of a model can be challenging to obtain due to logistical, cost, and/or other considerations.

There is a general desire for systems and methods for generating structural representations of non-human objects, and in particular for describing plant structure via machine learning models trainable in unsupervised and/or semisupervised contexts.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides systems and methods for training a machine learning model for generating a structural representation of a plant. The system comprises one or more processors and a memory storing instructions which cause the one or more processors to perform operations comprising the method. The method performed by the processors comprises: transforming, by an encoder, an input plant image to a predicted structural representation based on parameters of the encoder, the input plant image one of a plurality of plant images, each plant image representing a plant having a plurality of connected plant structures, and the predicted structural representation representing predicted connections between the plant structures of the input plant image; transforming, by a decoder, the predicted structural representation to a reconstructed plant image based on parameters of the decoder; classifying, by a discriminator, the reconstructed plant image as having been generated based on one of: the ground truth training dataset or parameters of the encoder to generate a classification based on parameters of the discriminator; and training parameters of the encoder based on the classification.

In some embodiments, the method comprises training the discriminator by: transforming, by the decoder, a ground-truth structural representation from a ground truth training dataset of predetermined structural representations to a second reconstructed plant image; transforming, by the decoder, a second predicted structural representation to a third reconstructed plant image based on parameters of the decoder, the second predicted structural representation generated by the encoder based on parameters of the encoder; classifying, by the discriminator, each of the second and third reconstructed plant images as having been generated based on one of: the ground truth training dataset or parameters of the encoder to generate respective second and third classifications based on parameters of the discriminator; and training parameters of the discriminator based on the second and third classifications.

In some embodiments, transforming the predicted structural representation to the reconstructed plant image comprises transforming the predicted structural representation to the first reconstructed plant image based on a texture representation separate from the predicted structural representation. In some embodiments, the method comprises transforming, by a texture encoder, the input plant image to the texture representation, the texture representation comprising a relatively lower-dimensional encoding than the input plant image. In some embodiments, the method comprises training parameters of the texture encoder based on the input plant image, the reconstructed plant image, and the classification.

In some embodiments, training parameters of the encoder comprises training parameters of the encoder based on the input plant image and the reconstructed plant image. In some embodiments, training the parameters of the encoder comprises determining a value of an objective function based on a difference between the input plant image and the reconstructed plant image; determining a gradient of the objective function relative to parameters of the encoder based on the difference; and updating parameters of the encoder based on the gradient.

In some embodiments, training parameters of the encoder comprises semisupervised training of parameters of the encoder, the semisupervised training comprising: transforming a first number of the plurality of plant images to a plurality of predicted plant structural representations by the encoder; transforming a second number of ground-truth structural representations from the ground truth training dataset to a plurality of reconstructed plant images by the decoder, the first number greater than the second number; and training the parameters of the encoder based on the plurality of reconstructed plant images and the plurality of plant images. In some embodiments, the ground truth training dataset comprises at most a number of ground-truth structural representations no greater than: 1%, 2%, 3%, 4%, 5%, 10%, 20%, 30%, 40%, 50%, 60%, 70%, 80%, or 90% of a number of plant images of the plurality of plant images. In some embodiments, the ground-truth structural representations of the ground-truth training dataset represent a plurality of plants other than the plants represented by the plurality of plant images.

In some embodiments, training parameters of the encoder comprises, for each of the predicted connections of the predicted structural representation, determining a plant morphology of the predicted connection and training the encoder based on the plant morphology. In some embodiments, determining the plant morphology comprises determining a branching characteristic, the branching characteristic comprising at least one of: number of branches, branch length, average branch length, branch type, branch curvature, and/or branch endpoint location. In some embodiments, the branching characteristic comprises branch type and determining the branching characteristic comprises determining, for at least one predicted connection, that the at least one predicted connection comprises a branch type of: tip-tip, tip-junction, junction-junction, path-path. In some embodiments, training parameters of the encoder comprises training parameters of the encoder to incentivize tip-junction branch types relative to one or more of tip-tip, junction-junction, and path-path branch types.

In some embodiments, training parameters of the encoder comprises halting training based on the plant morphology.

In some embodiments, training parameters of the encoder comprises determining a value of an objective function based on the plant morphology and training parameters of the encoder based on the value of the objective function. In some embodiments, the plant morphology comprises connectivity of the predicted connections, the method comprises determining a value of an objective function based on a shape prior representing connectivity of the predicted connections, and training parameters of the encoder comprises training parameters of the encoder based on the value of the objective function.

In some embodiments, the method comprises transforming the predicted structural representation to a polar predicted structural representation having polar coordinates and determining the value of the objective function comprises determining a difference between the polar predicted structural representation and the shape prior in a polar domain. In some embodiments, transforming the predicted structural representation to the polar predicted structural representation comprises determining a center point of the predicted structural representation and transforming the predicted structural representation to the polar predicted structural representation based on the center point. In some embodiments, determining the center point of the predicted structural representation comprises determining a center point of the input plant image and identifying a corresponding point in the predicted structural representation as the center point of the predicted structural representation.

In some embodiments, training parameters of the encoder comprises determining a value of an objective function based on one or more structural classifications generated by classifying the predicted structural representation, by one or more structure discriminators, as having been drawn from the ground truth training dataset or generated by the encoder, the value of the objective function based on the one or more structural classifications. In some embodiments, the one or more structure discriminators comprises a cartesian structure discriminator and classifying the predicted structural representation comprises generating a cartesian classification based on an image depicting the predicted structural representation comprising cartesian coordinates.

In some embodiments, the one or more structure discriminators comprises a polar structure discriminator and classifying the predicted structural representation comprises generating a polar classification based on an image of the predicted structural representation comprising polar coordinates. In some embodiments, the method comprises determining a center point of a cartesian predicted structural representation and transforming the cartesian predicted structural representation to the predicted structural representation comprising polar coordinates. In some embodiments, determining the center point of the cartesian predicted structural representation comprises determining a center point of the input plant image and identifying a corresponding point in the cartesian predicted structural representation as the center point of the cartesian predicted structural representation.

In some embodiments, training parameters of the encoder comprises determining a value of an objective function based on one or more reconstruction classifications generated by classifying the reconstructed plant image, by one or more reconstruction discriminators, as having been generated by the decoder or drawn from the plurality of plant images, the value of the objective function based on the one or more reconstruction classifications. In some embodiments, the one or more reconstruction discriminators comprises a first reconstruction discriminator and classifying the reconstructed plant representation by the first reconstruction discriminator comprises classifying the reconstructed plant image as having been generated by the decoder based on a ground-truth structural representation from the ground-truth training dataset or drawn from the plurality of plant images. In some embodiments, the one or more reconstruction discriminators comprises a first reconstruction discriminator and classifying the reconstructed plant representation by the first reconstruction discriminator comprises classifying the reconstructed plant image as having been generated by the decoder based on the predicted structural representation generated by the encoder or drawn from the plurality of plant images.

One aspect of the invention provides systems and methods for generating a structural representation for a plant by a machine learning model. The system comprises one or more processors and a memory storing instructions which cause the one or more processors to perform operations comprising the method. The method performed by the processors comprises: transforming, by an encoder, an input plant image to a predicted structural representation based on parameters of the encoder, the parameters of the encoder trained as described above or elsewhere herein.

One aspect of the invention provides systems and methods for training a machine learning model for generating a structural representation for an object. The system comprises one or more processors and a memory storing instructions which cause the one or more processors to perform operations comprising the method. The method performed by the processors comprises: transforming, by an encoder, an input image depicting the object to a predicted structural representation based on parameters of the encoder, the input image one of a plurality of images, each image representing an object having a structure and a texture, and the predicted structural representation representing the structure of the object; transforming, by a decoder, the predicted structural representation to a reconstructed image based on parameters of the decoder; classifying, by a discriminator, the reconstructed image as having been generated based on one of: a ground truth training dataset or parameters of the encoder to generate a classification based on parameters of the discriminator; and training parameters of the encoder based on the classification.

In some embodiments, the method comprises training the discriminator by: transforming, by the decoder, a ground-truth structural representation from a ground truth training dataset of predetermined structural representations to a second reconstructed image; transforming, by the decoder, a second predicted structural representation to a third reconstructed plant image based on parameters of the decoder, the second predicted structural representation generated by the encoder based on parameters of the encoder; classifying, by the discriminator, each of the second and third reconstructed images as having been generated based on one of the ground truth training dataset or parameters of the encoder to generate respective second and third classifications based on parameters of the discriminator; and training parameters of the discriminator based on the second and third classifications.

In some embodiments, transforming the predicted structural representation to the reconstructed image comprises transforming the predicted structural representation to the first reconstructed image based on a texture representation separate from the predicted structural representation. In some embodiments, the method comprises transforming, by a texture encoder, the input image to the texture representation, the texture representation comprising a relatively lower-dimensional encoding than the input image. In some embodiments, the method comprises training parameters of the texture encoder based on the input image, the reconstructed image, and the classification.

In some embodiments, training parameters of the encoder comprises training parameters of the encoder based on the input image and the reconstructed image. In some embodiments, training the parameters of the encoder comprises determining a value of an objective function based on a difference between the input image and the reconstructed image; determining a gradient of the objective function relative to parameters of the encoder based on the difference; and updating parameters of the encoder based on the gradient.

In some embodiments, training parameters of the encoder comprises semisupervised training of parameters of the encoder, the semisupervised training comprising: transforming a first number of the plurality of images to a plurality of predicted object structural representations by the encoder; transforming a second number of ground-truth structural representations from the ground truth training dataset to a plurality of reconstructed images by the decoder, the first number greater than the second number; and training the parameters of the encoder based on the plurality of reconstructed images and the plurality of images. In some embodiments, the ground truth training dataset comprises at most a number of ground-truth structural representations no greater than: 1%, 2%, 3%, 4%, 5%, 10%, 20%, 30%, 40%, 50%, 60%, 70%, 80%, or 90% of a number of images of the plurality of images. In some embodiments, the ground-truth structural representations of the ground-truth training dataset represent a plurality of objects other than the objects represented by the plurality of images.

In some embodiments, training parameters of the encoder comprises determining a value of an objective function based on one or more structural classifications generated by classifying the predicted structural representation, by one or more structure discriminators, as having been drawn from the ground truth training dataset or generated by the encoder, the value of the objective function based on the one or more structural classifications. In some embodiments, the one or more structure discriminators comprises a cartesian structure discriminator and classifying the predicted structural representation comprises generating a cartesian classification based on an image of the predicted structural representation comprising cartesian coordinates.

In some embodiments, the one or more structure discriminators comprises a polar structure discriminator and classifying the predicted structural representation comprises generating a polar classification based on an image of the predicted structural representation comprising polar coordinates. In some embodiments, the method comprises determining a center point of a cartesian predicted structural representation and transforming the cartesian predicted structural representation to the predicted structural representation comprising polar coordinates. In some embodiments, determining the center point of the cartesian predicted structural representation comprises determining a center point of the input image and identifying a corresponding point in the cartesian predicted structural representation as the center point of the cartesian predicted structural representation.

In some embodiments, training parameters of the encoder comprises determining a value of an objective function based on one or more reconstruction classifications generated by classifying the reconstructed image, by one or more reconstruction discriminators, as having been generated by the decoder or drawn from the plurality of images, the value of the objective function based on the one or more reconstruction classifications. In some embodiments, the one or more reconstruction discriminators comprises a first reconstruction discriminator and classifying the reconstructed object representation by the first reconstruction discriminator comprises classifying the reconstructed image as having been generated by the decoder based on a ground-truth structural representation from the ground-truth training dataset or drawn from the plurality of images. In some embodiments, the one or more reconstruction discriminators comprises a first reconstruction discriminator and classifying the reconstructed object representation by the first reconstruction discriminator comprises classifying the reconstructed image as having been generated by the decoder based on the predicted structural representation generated by the encoder or drawn from the plurality of images.

One aspect of the invention provides systems and methods for generating a structural representation for an object by a machine learning model. The system comprises one or more processors and a memory storing instructions which cause the one or more processors to perform operations comprising the method. The method performed by the processors comprises: transforming, by an encoder, an input image to a predicted structural representation based on parameters of the encoder, the parameters of the encoder trained as described above or elsewhere herein.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows schematically an exemplary system for training a machine learning model for generating a structural representation of a plant.

FIG. 2A shows schematically an exemplary system for training an exemplary contraband discriminator of the system of FIG. 1 in a first mode of operation relating to ground truth training data.

FIG. 2B shows schematically an exemplary system for training an exemplary contraband discriminator of the system of FIG. 1 in a second mode of operation relating to predictions generated by an exemplary encoder of the system of FIG. 1.

FIG. 3 shows schematically an exemplary system for generating a structural representation of a plant by a machine learning model incorporating an exemplary encoder of the system of FIG. 1.

FIG. 4 is a flowchart of an exemplary method for training a machine learning model for generating a structural representation of a plant.

FIG. 5 is a flowchart of an exemplary method for generating a structural representation of a plant by a machine learning model.

FIG. 6 shows a first exemplary operating environment that includes at least one computing system for performing methods described herein, such as the methods of FIGS. 4 and 5.

FIG. 7A shows an example set of results generated by an exemplary implementation of the system of FIG. 3 trained by an exemplary implementation of the system of FIG. 1.

FIG. 7B shows a table describing branches of each plant skeleton of FIG. 7A.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Aspects of the present disclosure provide systems and methods for training a machine learning model for generating a structural representation of a plant, as well as systems and methods for generating a structural representation of a plant via such a model. In at least one embodiment, the training method involves encoding a plant image into a structural representation of the plant (e.g. an image of a plant “skeleton”, describing the connectivity of the plant's stem/branches/leaves/etc.) via an encoder, decoding the structural representation of the plant into a reconstructed image of the plant via a decoder, and classifying the reconstructed image as having been generated based on a ground-truth structural representation (e.g. provided by the user) or output of the encoder.

Classification during training is performed by a discriminator (sometimes referred to herein as the contraband discriminator). The discriminator is trained based on a set of ground-truth plant structural representations (e.g. hand-drawn plant skeleton images). The parameters of the encoder (and, optionally, of other elements such as the decoder) are trained to incentivize the encoder to produce structural representations which do not “smuggle” texture information (e.g. appearance, such as color) based on the classifications. Texture information may be separately represented, e.g. by encoding the texture of a plant image via a texture encoder and/or by generating a texture encoding by sampling from a probability distribution. By incentivizing “clean” structural representations from the encoder, the accuracy of such representations may be improved without requiring the contraband discriminator to constrain the plant representation via a k-keypoint bottleneck specifically constructed to mimic plant morphology. The encoder, once trained, may be used to generate structural representations from plant images without necessarily requiring the use of the decoder and/or the discriminator.

In at least some implementations, such training methods can permit largely unsupervised and/or semisupervised implementations, e.g. by providing a small number (e.g. 100) of ground-truth plant structural representations (e.g. drawings of plant skeletons) and a comparatively larger number of plant images. The ground truth plant structural representations do not necessarily need to describe the structure of any specific plants depicted in the plant images.

The present disclosure is not limited to plants, although plant structural representations are the technical context in which aspects of the present disclosure were initially developed. Aspects of the present disclosure further provide systems and methods for training a machine learning model for generating a structural representation of objects (including objects other than plants), such as humans, animals, articles of manufacture, and/or other objects. The contraband discriminator in such aspects may be trained on a set of ground-truth structural representations of the objects in question, such as wireframe images of human skeletons (and/or animal skeletons, etc.). Extensions of the present techniques to non-plant objects are described in greater detail elsewhere herein.

### A System for Training a Machine Learning Model for Generating Plant Structural Representations

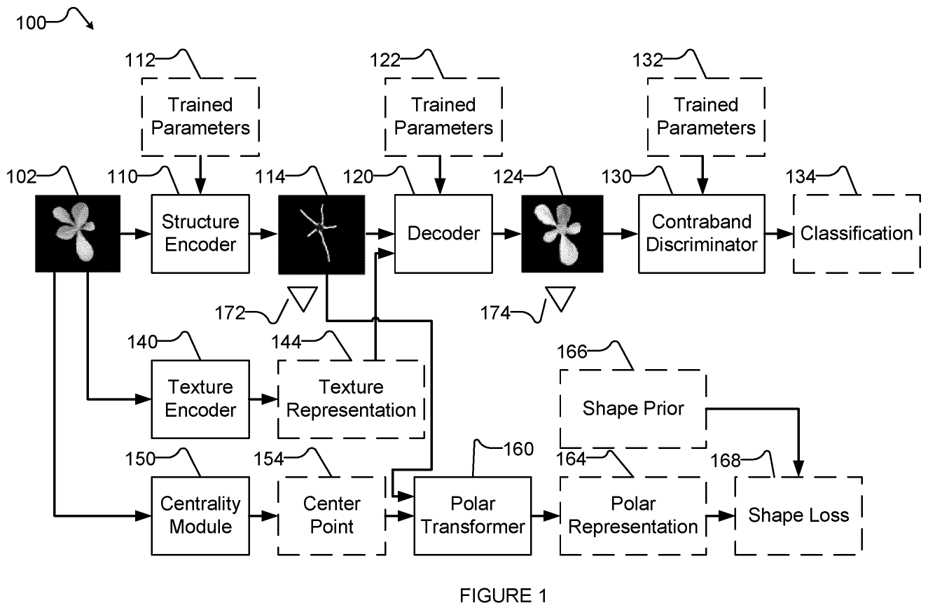

FIG. 1 shows schematically an exemplary system 100 for training a machine learning model for generating a structural representation of a plant. System 100 comprises a computing system as described in greater detail elsewhere herein. System 100 may interact with various inputs and outputs (shown in dashed lines), which are not necessarily part of system 100, although in some embodiments some or all of these inputs and outputs are part of system 100 (e.g. in an example embodiment, trained parameters 112, 122, and/or 132 are part of system 100).

System 100 comprises an encoder 110, a decoder 120, and a discriminator 130. For convenience of distinguishing encoder 110 and discriminator 130 from optional other elements (e.g. texture encoder 140, discriminators 172, 174), encoder 110 and discriminator 130 are sometimes referred to as a “structure encoder” and a “contraband discriminator”, respectively, without limiting either such element. The term “encoder”, as used herein, includes models which transform one image to another (e.g. via image-to-image translation), and does not necessarily require the encoder's output to be restricted to a lower-dimensional space (e.g. as may be the case with encoders which produce a latent representation as output).

Structure encoder 110 comprises a machine learning model having parameters 112. Structure encoder 110 transforms an input plant image 102 to a predicted structural representation 114. The input plant image represents a plant having a plurality of connected plan structures, such as one or more stems, leaves, trunks, roots, and/or other plant structures. For example, encoder 110 may comprise an image-to-image translation model which receives an input plant image 102 and generates a predicted structural representation 114 comprising an image (e.g. a raster image, a vector image, and/or any other type of image) representing a predicted structure of the plant of image 102. The predicted plant structure may comprise, for example, a skeleton comprising various junctions and branches arranged to correspond to structures of the plant of image 102, e.g. as depicted in FIG. 1.

In some implementations, encoder 110 comprises a neural network. For example, encoder 110 may comprise a convolutional neural network. In at least one exemplary implementation, encoder 110 comprises a U-Net model, e.g. as described by Ronneberger et al., U-Net: Convolutional Networks for Biomedical Image Segmentation, arXiv: 1505.04597 [cs.CV]. System 100 trains parameters 112 of encoder 110.

Decoder 120 comprises a machine learning model having parameters 122. Decoder 120 transforms a structural representation of a plant, such as predicted structural representation 114, to a reconstructed plant image 124. The input domain of decoder 120 comprises, at least in part, the output domain of encoder 110 (i.e. a domain of structural representations of plants). The output domain of decoder 120 comprises, at least in part, the input domain of encoder 110 (i.e. a domain of plant images). For example, decoder 120 may comprise an image-to-image translation model which receives a structural representation of a plant, such as predicted structural representation 114, comprising an image (e.g. a raster image, a vector image, and/or any other type of image) and generates a reconstructed plant image 124.

In some embodiments, decoder 120 also receives as input a texture representation 144. Texture representation 144 may be generated based on a texture encoder 140 which transforms plant image 102 to texture representation 144. In some embodiments texture representation 144 is a latent code, i.e. a representation in a relatively lower-dimensional domain than plant image 102 without necessarily being intelligible to humans or possessing a known/predetermined distribution over its potential values. For example, whereas in some implementations plant image 102 comprises thousands of pixels, texture representation 144 may comprise a relatively smaller number of variables, such as 1, 16, 32, 100, or any other number therebetween or otherwise less than the number of pixels (and/or vectors or other component) of plant image 102. In at least one example implementation, texture representation 144 comprises an eight-variable vector.

Texture encoder 140 may comprise, for example, a machine learning model having trained parameters (not shown). In some implementations, texture encoder 140 comprises a neural network and may be trained together with the parameters of decoder 120 (and, optionally, of encoder 110). For instance, texture encoder 140 may comprise a deep neural network encoder in a BicycleGAN model as described by Zhu et al., Toward Multimodal Image-to-Image Translation, arXiv:1711.11586 [cs.CV] and/or as further described by Jakab et al.; Self-Supervised Learning of Interpretable Keypoints From Unlabelled Videos, Proceedings of the IEEE/CVF Conference on Computer Vision and Pattern Recognition (CVPR), 2020, pp. 8787-8797.

Providing texture encoder 140 during training by system 100 can assist with separating structure information (via structure encoder 110) from texture information (sometimes called appearance or style information; via texture encoder 140). However, such separation is not sufficient to prevent transmission (or “smuggling”) of texture information in predicted structural representation 114. This is at least partially addressed by Jakab et al. (cited above) by passing a predicted human skeleton through a bottleneck that enforces human morphology. This approach is challenging to apply to the more variegated context of plant morphologies.

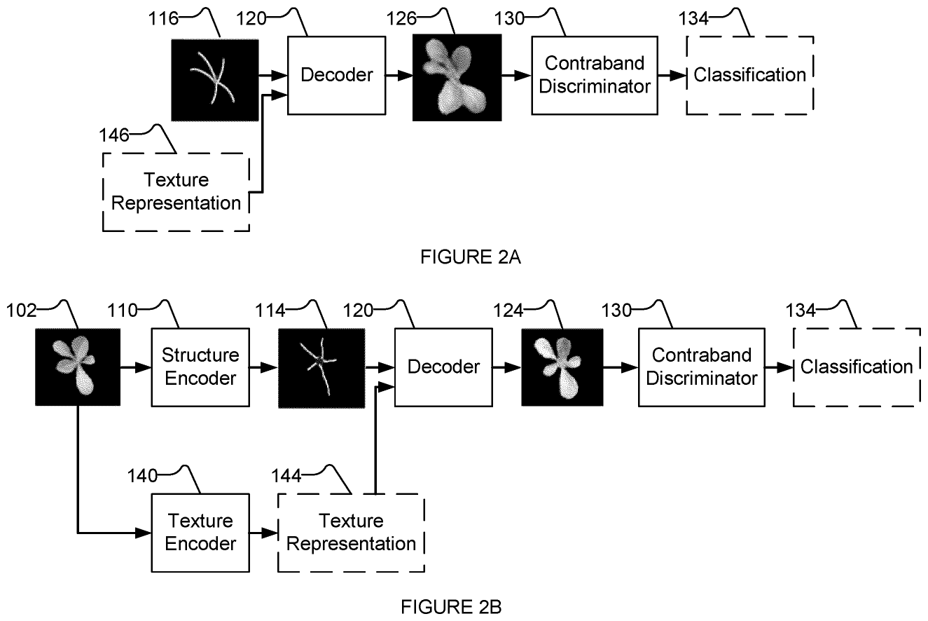

System 100 provides contraband discriminator 130, having parameters 132. Contraband discriminator 130 receives a reconstructed plant image 124 and generates a classification 134. Discriminator 130 (and thus classification 134) classifies reconstructed plant image 124 as having been generated based on either a ground truth value (not shown in FIG. 1; see ground truth structural representation 116 of FIG. 2A) or a predicted structural representation 114 generated by encoder 110 (i.e. based on parameters of encoder 110). If we denote decoder 120 as G, a ground truth structural representation as real, and predicted structural representation 114 as fake, we can say that discriminator 130 discriminates between G(real) and G(fake). In at least some embodiments, decoder 120 and discriminator 130 form a generative adversarial network (GAN) in which decoder 120 (in at least some embodiments, together with encoder 110) is the GAN's generator and discriminator 130 is the GAN's discriminator. In some embodiments, training of parameters 132 of discriminator 130 is interleaved with training of parameters 112, 122 of encoder 110 and decoder 122. Such interleaving may comprise, for example, alternating repeatedly between a first mode where parameters 112, 122 are trained while holding parameters 132 fixed and a second mode where parameters 132 are trained while holding parameters 112, 122 fixed.

Parameters 112, 122, and 132 may be trained by system 100 via any suitable approach. In some embodiments, parameters 112, 122, and/or 132 are trained by system 100 via backpropagation based on an objective function. (“Objective function”, as used herein, includes loss functions.) The objective function may comprise various terms. In some embodiments, system 100 trains parameters 112 and 122 to optimize (e.g. minimize/maximize) an objective function comprising a contraband loss term based on classification 134; the contraband loss term disincentivizes (e.g. is large for) classifications 134 indicating that reconstructed plant image 124 is based on the output of encoder 110 (i.e. a classification as G(fake)) and/or incentivizes (e.g. is small for) classifications 134 indicating that reconstructed plant image 124 is based on a ground truth structural representation (i.e. a classification as G(real)).

In some embodiments, the objective function over which parameters 112 and 122 are trained includes terms such as a pixel-wise loss term L1 based on a difference between input plant image 102 and reconstructed plant image 124; a shape loss 168 based on a shape prior 166 (described in greater detail below); a structure loss based on a structure discriminator 172 (described in greater detail below); a reconstruction loss based on a reconstruction discriminator 174 (described in greater detail below); and/or other suitable terms, such as those described by Zhu and/or Jakab (cited above). For example, in at least one embodiment system 100 trains parameters 112 and 122 based on the following loss function [symbol] :

[symbol]

=L1+L_{contraband}+Lₛₕₐₚₑ+L_{structure}

Where L1 is as described above, L_{contraband} is an error term describing the weight that contraband discriminator 130 assigns in prediction 134 to a reconstructed plant image 124 being generated based on the output of encoder 110, Lₛₕₐₚₑ is shape loss 168, and L_{structure} is an error across structure discriminator 172 (this may be e.g. a sum of errors in embodiments with multiple discriminators 172). Training of parameters 132 of contraband discriminator 130 is discussed in greater detail below with reference to FIGS. 2A and 2B.

In some embodiments, system 100 trains parameters 112, 122 based on the relative conformance of predicted structural representation 114 to expected plant morphologies. For example, system 100 may determine a plant morphology indicated by predicted structural representation 114 and train parameters 112, 122 based on that morphology.

In some embodiments, training based on plant morphology comprises describing predicted structural representation 114 via an expert system, such as SKAN, e.g. as described by Nunez-Iglesias, A new Python library to analyse skeleton images confirms malaria parasite remodelling of the red blood cell membrane skeleton, PeerJ vol. 6 e4312. 15 Feb. 2018, doi:10.7717/peerj.4312, to determine which branches (which, in the language of SKAN, describes any skeletal segment, and may for example correspond to a stem, leaf, root, branch, or other portion of a plant) connect to which other branches and in what manner. For example, the expert system may determine one or more branching characteristics, such as: number of branches, branch length, average branch length, branch type, branch curvature, and/or branch endpoint location. Parameters 112, 122 may be trained to disincentivize certain morphologies, including branch types such as: tip-tip connections (e.g. two leaves connecting to each other at their terminal ends), junction-junction connections (e.g. branches extending between trunks), and/or path-path connections. Parameters 112, 122 may be trained to incentivize certain morphologies, including branch types such as tip-junction connections (e.g. branches extending from the trunk, leaves extending from branches).

In some embodiments, training based on plant morphology comprises determining a shape loss 168 based on a shape prior 166 and predicted structural representation 114. The shape loss forms a term of the objective function and thus influences the training of parameters 112, 122. In some embodiments, the shape prior represents connectivity of connections of an expected plant skeleton, e.g. by representing generally radially-extending branches from a center point. In some embodiments, the shape prior penalizes disconnected structural representations (e.g. plant skeletons wherein branches exist with no connection between them). System 100 may compare predicted structural representation 114 to the shape prior (e.g. via an L1 and/or L2 pixel-wise loss) to determine shape loss 168. In some embodiments, system 100 performs such a comparison in the polar domain. For certain forms of shape prior 166, such as those representing radial structure (e.g. in a context where plant images 102 depict plants as seen from above), polar coordinates can be advantageous over cartesian coordinates, as convolutions along rows can correspond to enforcing radial connectivity. (Additionally, or alternatively, cartesian coordinates can tend to overemphasize local error in at least some circumstances.) In some embodiments, system 100 transforms predicted structural representation 114 to polar coordinates via polar transformer 160, thus generating a polar predicted structural representation 164 for comparison to shape prior 166.

In some embodiments, polar transformation (e.g. via polar transformer 160) is assisted by determining a center point 154 via centrality module 150. Centrality module 150 determines a center point of the plant depicted by plant image 102 and/or represented structurally by predicted structural representation 114. In some embodiments, centrality module 150 comprises a neural network trained over plant images corresponding to ground-truth structural representations (some or all of which may optionally be used to train discriminator 130). The plant images may comprise input plant images 102 for which ground-truth structural representations are provided by a user, and/or the plant images may comprise reconstructed plant images 124 generated by decoder 120 from such ground-truth structural representations. (The latter case avoids or reduces the need for labelled plant images.)

The ground-truth structural representations over which centrality module 150 is trained are annotated with center points. The center points may correspond, for example, to a center junction point, such as a center junction point of a plant skeleton from which skeleton segments extend; a location of a trunk or other structure of the plant from which other plant structures extend; to a center of mass of the plant; and/or to some other reference point suitable for transforming predicted structural representation 114 to polar coordinates. In some embodiments, centrality module 150 receives plant image 102 as input and generates a predicted center point 154 as output. System 100 may identify a corresponding point in predicted structural representation 114 (e.g. having the same coordinates as center point 154) as the center point of predicted structural representation 114. Polar transformer 160 may use center point 154 as a basis on which to transform predicted structural representation 114 to polar coordinates. In some embodiments, reconstructed plant images 124 are detached from a backpropagation graph when training centrality module 150 to avoid recursion with decoder 120, e.g. by not backpropagating a loss term over the output of centrality module 150 over parameters of other elements of system 100 (e.g. parameters 112, 122, 132).

In some embodiments, system 100 halts training based on plant morphology. Pixel-to-pixel comparisons can overemphasize small localization errors, whereas features such as branch number and/or branch length (e.g. determined via SKAN or any other suitable technique) may converge over the course of training. In some embodiments, as system 100 trains parameters 112, 122, system 100 periodically determines a measure of plant morphological validity (e.g. number of branches, branch length, and/or some combination thereof) based on a held-out validation set. When the measure of plant morphological validity converges, meets a threshold, or otherwise satisfies some halting criterion, system 100 halts training of parameters 112, 122. In some embodiments, system 100 trains parameters 112, 122 over a predetermined number of epochs, periodically determines a measure of plant morphological validity based on a held-out validation set (e.g. after every epoch, after every 2^{nd} epoch, after every 5^{th} epoch, after every 10^{th} epoch, etc.), stores a copy of parameters 112 (and, optionally, other parameters, such as parameters 122 and/or 132) corresponding to each such measurement, and selects a copy of parameters 112 to use as trained parameters for inference based on the corresponding measurement. For instance, the copy of parameters 112 having a lowest-valued measurement (where lower-valued measurements correspond to more valid plant morphology than relatively higher-valued measurements) may be selected and used for inference. This can be advantageous in certain circumstances, as (e.g.) a pixelwise loss term between plant image 102 and reconstructed plant image 124 may not clearly indicate when to halt training.

In some embodiments, system 100 comprises one or more structure discriminators 172 and/or one or more reconstruction discriminators 174. System 100 may train parameters 112, 122 based on classifications generated by such discriminators 172, 174. In some embodiments, structure encoder 110 and a structure discriminator 172 are trained as a GAN, with encoder 110 being the generator, and/or decoder 120 and reconstruction discriminator 174 are trained as a GAN, with decoder 120 being the generator.

Structure discriminators 172 receive predicted structural representation 114 and discriminate between predicted structural representations 114 generated by encoder 110 and ground-truth structural representations. Training over such classifications can incentivize encoder 110 to generate predicted structural representations which are similar to ground-truth structural representations (although the effect is not generally the same as providing contraband discriminator 130). In some embodiments, system 100 provides two structure discriminators 172: one which receives predicted structural representation 114 comprising cartesian coordinates and one which receives a structural representation comprising polar coordinates (e.g. polar structural representation 164).

Reconstruction discriminators 174 receive plant images and discriminate between reconstructed plant images 124 generated by decoder 120 and real plant images (e.g. plant images 102). Training over such classifications can incentivize decoder 120 to generate reconstructed plant images which are similar to real plant images. In some embodiments, system 100 provides two reconstruction discriminators 174: one which discriminates between reconstructed plant images 124 generated by decoder 120 based on ground-truth structural representations (e.g. representations 116; such plant images can be denoted G(real)) and real plant images and one which discriminates between reconstructed plant images 124 generated by decoder 120 based on predicted structural representation 114 generated by encoder 110 (e.g. representations 114; such plant images can be denoted G(fake)).

FIG. 2A shows schematically an exemplary system for training contraband discriminator 130 in a first mode of operation relating to ground truth training data. Decoder 120 receives a ground-truth structural representation 116 from a ground truth training dataset of predetermined structural representations and transforms representation 116 to a reconstructed plant image 126, denoted G(real). Optionally, decoder 120 also receives as input a texture representation 146, which may be generated by texture encoder 140 based on a plant image 102, randomly sampled (e.g. from a Gaussian, uniform, and/or other distribution), and/or generated in any other suitable way. Contraband discriminator 130 receives reconstructed plant image 126 as input and classifies reconstructed plant image 126 as having been generated (by decoder 120) based on one of: the ground truth training dataset or parameters of encoder 110, thereby generating classification 134. Alternatively put, contraband discriminator classifies reconstructed plant image 126 as either G(real) or G(fake).

FIG. 2B shows schematically an exemplary system for training contraband discriminator 130 in a second mode of operation relating to predictions generated by encoder 110. Decoder 120 receives a predicted structural representation 114 generated by encoder 110 based on an input plant image 102 and transforms representation 114 to a reconstructed plant image 124, denoted G(fake). Optionally, decoder 120 also receives as input a texture representation 144, which may be generated by texture encoder 140 based on plant image 102, randomly sampled (e.g. from a Gaussian, uniform, and/or other distribution), and/or generated in any other suitable way. Contraband discriminator 130 receives reconstructed plant image 126 as input and classifies reconstructed plant image 126 as having been generated (by decoder 120) based on one of: the ground truth training dataset or parameters of encoder 110, thereby generating classification 134. Alternatively put, contraband discriminator classifies reconstructed plant image 126 as either G(real) or G(fake).

System 100 trains parameters 132 of contraband discriminator 130 based on the accuracy of classifications 134 across the first and second modes of operation of FIGS. 2A and 2B. As noted elsewhere herein, parameters 132 may be held fixed during training of parameters 112, 122. Parameters 132 may be trained on a different objective function than parameters 112, 122. System 100 may interleave training of parameters 132 and training of parameters 112, 122, e.g. by training parameters 132 for one or more epochs while holding parameters 112, 122 fixed, then training parameters 112, 122 for one or more epochs while holding parameters 112, 122 fixed; this process may be repeated any suitable number of times, optionally with additional and/or alternative modes of operation used over the course of training. In some embodiments, parameters of texture encoder 140, centrality module 150, structure discriminators 172, and/or reconstruction discriminators 174 are trained together with parameters of encoder 110 and/or decoder 120, and may likewise be held fixed during training of parameters 132.

### A System for Generating Plant Structural Representations

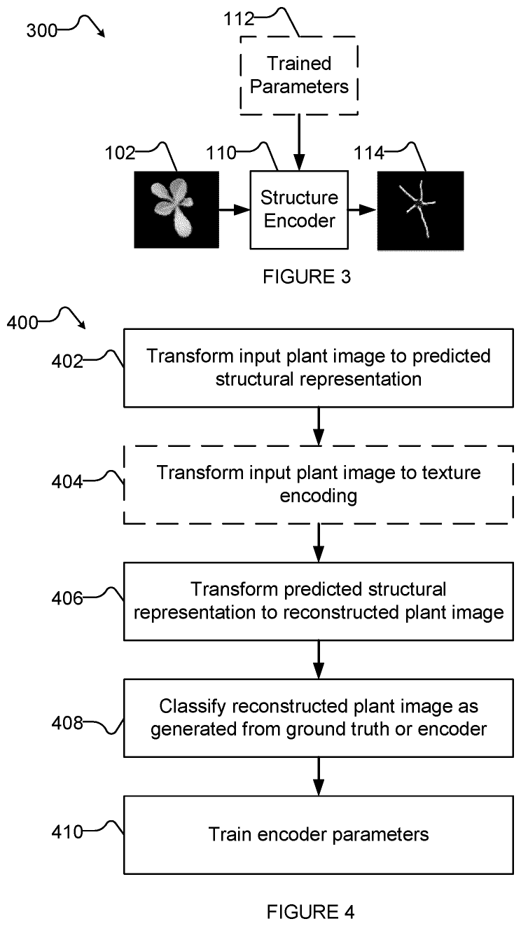

FIG. 3 shows schematically an exemplary system 300 for generating a structural representation of a plant by a machine learning model incorporating encoder 110 of system 100. System 300 comprises a structure encoder 110 which receives a plant image as input and transforms the plant image to a predicted structural representation based on parameters 112. Parameters 112 were trained as described elsewhere herein (e.g. with reference to FIGS. 1, 2A, and 2B) based on plant images (and, via the contraband discriminator, via a ground-truth data set of structural representations).

In at least some embodiments, system 300 does not require the use of decoder 120, contraband discriminator 130, texture encoder 140, centrality module 150, polar transformer 160, discriminators 172, 174, reconstructed plant images 124, classifications 134, texture representations 144, center point 154, shape loss 168, and/or any other elements of shown in FIG. 1 but not shown in FIG. 3.

### A Method for Training a Machine Learning Model for Generating Plant Structural Representations

FIG. 4 is a flowchart of an exemplary method 400 for training a machine learning model for generating a structural representation of a plant, such as the machine learning models of systems 100 and/or 300, described elsewhere herein. Method 400 is performed by a processor, such as a processor of computing system 600, described elsewhere herein.

At act 402, the processor transforms an input plant image to a predicted structural representation based on parameters of an encoder. The encoder receives the input plant image as input and generates the predicted structural representation as output based on its parameters. The encoder may comprise, for example, encoder 110 of systems 100 and/or 300. The input plant image is one of a plurality of plant images, each representing a plant having a plurality of connected plant structures. The predicted structural representation generated by the encoder represents predicted connections between the plant structures of the input plant image. Early in training this representation may not be apparent, and even when fully trained such representations may be imperfect, but in general the training of method 400, when provided with suitable training data, will tend to form a tendency of the encoder to generate reasonable predicted structural representations. The structural representations may comprise plant “skeletons”, as described elsewhere herein and/or as illustrated in FIGS. 1-3.

At act 404, the processor optionally transforms the input plant image to the texture representation by a texture encoder. The texture encoder receives the input plant image and/or the predicted structural representation as input and generates the texture representation as output based on its parameters. The texture encoder may comprise, for example, texture encoder 140 of system 100. The texture representation may comprise a relatively lower-dimensional encoding than the input plant image. Examples of such encodings are provided elsewhere herein; for instance, the texture encoding may comprise an eight-variable latent encoding.

At act 406, the processor transforms the predicted structural representation to a reconstructed plant image based on parameters of a decoder. The decoder receives a structural representation as input and generates a reconstructed plant image as output based on its parameters. In some embodiments the decoder also receives the texture representation as input separately from the predicted structural representation. The decoder may comprise, for example, decoder 120 of system 100. In at least some embodiments the reconstructed plant image belongs to the same domain as the input plant image.

At act 408, the processor classifies the reconstructed plant image as having been generated based on one of: the ground truth training dataset or parameters of the encoder to generate a classification based on parameters of a discriminator. The discriminator receives reconstructed plant images as input and generates the aforementioned classification of that input as output. As noted elsewhere herein, the classification can be denoted as describing the reconstructed plant image as G(real) or G(fake). In this case the reconstructed plant image provided as input to the discriminator has been generated by the decoder based on the predicted structural representation generated at act 406, but in general the discriminator may receive plant images of other provenances, such as (e.g. in the case of the example training according to the system of FIGS. 2A and 2B) reconstructed plant images generated by the decoder based on ground-truth structural representations. The discriminator may comprise, for example, contraband discriminator 130 of system 100.

At act 410, the processor trains parameters of the encoder based on the classification. Such training may be performed as described with respect to system 100 and/or via any other suitable approach. For example, the parameters of the encoder (and optionally the parameters of other model elements, such as the decoder, texture encoder, structure/reconstruction discriminators, etc.) may be trained via a backpropagation approach such as is described by Zhu et al. in Toward Multimodal Image-to-Image Translation (cited above) and/or by Jakab et al. in Learning Human Pose from Unaligned Data through Image Translation (cited above). For instance, in at least some embodiments, the processor trains the parameters by determining a contraband loss term based on the classification, and optionally one or more other loss terms, such as a pixelwise loss between the input plant image and reconstructed plant image, loss terms relating to other model elements, a shape prior loss term, etc. A gradient of an objective function with respect to the parameters of the encoder (and optionally the parameters of other model elements) may be determined based on the contraband loss term (and optionally the other loss terms), and changes to such parameters may be backpropagated based on the gradient.

As an example, a classification of G(fake) (and/or of a higher probability of G(fake) than G(real)) may correspond to a relatively larger value for the contraband loss term than a classification of G(real) (and/or of a higher probability of G(real) than G(fake)). In suitable circumstances, a contraband loss term based on the classification can incentivize output of the encoder to omit “smuggled” texture information so as to provide “clean” structural representations similar to ground-truth structural representations to the decoder.

By discriminating based on reconstructed plant images, method 400 can, in suitable circumstances, avoid the need for labelled plant images. A relatively small number of plant structural representations can be used to train the discriminator, thereby enabling largely unsupervised (e.g. semisupervised) training.

In some embodiments, the discriminator's parameters are fixed during training of the parameters of the encoder. In some embodiments, the discriminator's parameters are predetermined. In some embodiments, method 400 involves interleaving training of the discriminator's parameters with training of the encoder's parameters, e.g. as described elsewhere herein with reference to FIGS. 2A and 2B. In some embodiments, the processor trains the discriminator to discriminate between G(real) and G(fake), i.e. between reconstructed plant images generated by the decoder based the ground truth training dataset or parameters of the encoder, respectively. For example, the processor may use the decoder to transform a ground-truth structural representation from a ground truth training dataset of predetermined structural representations to a G(real) reconstructed plant image and may transform a predicted structural representation (generated by the encoder) to a G(fake) reconstructed plant image. The processor may use the discriminator to classify each of the G(real) and G(fake) reconstructed plant images as having been generated based on one of: the ground truth training dataset or parameters of the encoder to generate respective second and third classifications based on parameters of the discriminator. The processor may train parameters of the discriminator based on those classifications. The parameters of the encoder (and some or all other model elements) may be held fixed during such discriminator training. The discriminator training may be performed in epochs preceding and/or interleaved with epochs wherein the encoder (and some or all other model elements) are trained; the parameters of the discriminator may be held fixed during such encoder training.

### A Method for Generating Plant Structural Representations

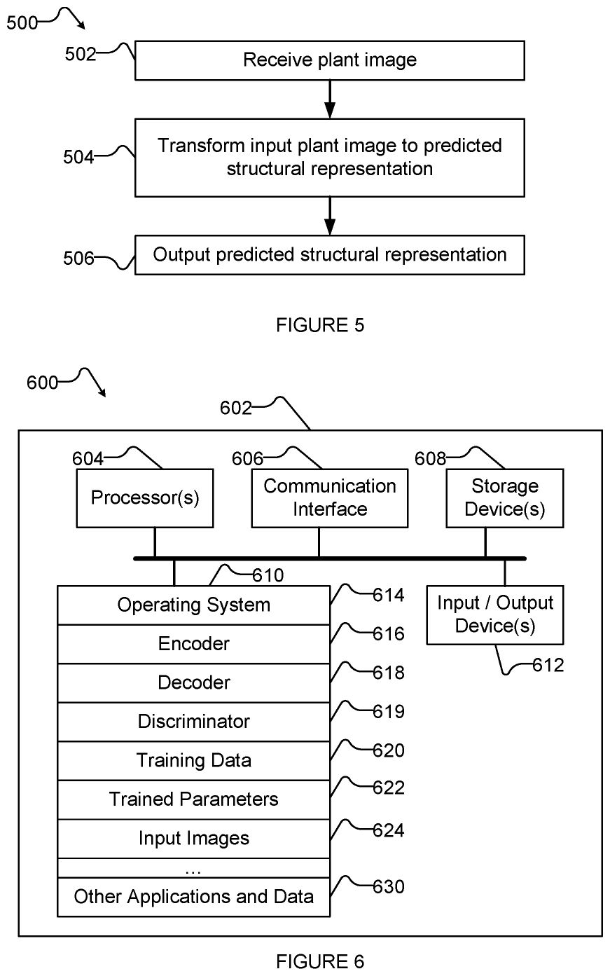

FIG. 5 is a flowchart of an exemplary method 500 for generating a structural representation of a plant by a machine learning model, such as the machine learning model of system 300. The machine learning model comprises an encoder having trained parameters. Method 500 is performed by a processor, such as a processor of computing system 600, described elsewhere herein.

At act 502, a plant image is received. The plant image shares one or more characteristics with at least one plant image over which the parameters of the encoder were trained. For example, if the encoder was trained over images of lettuce plants seen from above, the plant image may show a lettuce plant seen from above. As another example, the images may share a resolution; e.g. the encoder may be trained over 512×512 pixel images and may receive 512×512 pixel images as input. Although there may be differences between a plant image and any given plant image in the training set, in at least some embodiments the plant image received at act 502 is in the same domain of plant images as at least a portion of the plant images of the training set.

At act 504, the processor transforms the plant image to a predicted structural representation based on parameters of the encoder. This may comprise, for example, transforming the plant image by encoder 110 of systems 100 and/or 300 based on parameters 112. The encoder's parameters were trained as described elsewhere herein (e.g. with reference to FIGS. 1, 2A, and 2B) based on plant images (and, via the contraband discriminator, via a ground-truth data set of structural representations). Such training may occur prior to method 500 (e.g. such that the encoder's parameters are fixed during at least act 504) and/or may be interleaved with the acts of method 500 (e.g. if parameters are retrained alongside method 500).

At act 506, the processor provides the predicted plant structural representation as output, e.g. by displaying to a user, storing, transmitting, and/or otherwise providing predicted plant structural representation.

In at least some embodiments, method 500 involves the use of encoder 110 of system 100 and/or 300 but does not necessarily require the use of decoder 120, contraband discriminator 130, texture encoder 140, centrality module 150, polar transformer 160, discriminators 172, 174, reconstructed plant images 124, classifications 134, texture representations 144, center point 154, shape loss 168, and/or any other elements of shown in FIG. 1 but not shown in FIG. 3.

### Example System Implementation

FIG. 6 illustrates a first exemplary operating environment 600 that includes at least one computing system 602 for performing methods described herein. System 602 may be any suitable type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. System 602 may be configured in a network environment, a distributed environment, a multi-processor environment, and/or a stand-alone computing device having access to remote or local storage devices.

A computing system 602 may include one or more processors 604, a communication interface 606, one or more storage devices 608, one or more input and output devices 612, and a memory 610. A processor 604 may be any commercially available or customized processor and may include dual microprocessors and multi-processor architectures. The communication interface 606 facilitates wired or wireless communications between the computing system 602 and other devices. A storage device 608 may be a computer-readable medium that does not contain propagating signals, such as modulated data signals transmitted through a carrier wave. Examples of a storage device 608 include without limitation RAM, ROM, EEPROM, flash memory or other memory technology, CD-ROM, digital versatile disks (DVD), or other optical storage, magnetic cassettes, magnetic tape, magnetic disk storage. In at least some embodiments such embodiments of storage device 608 do not contain propagating signals, such as modulated data signals transmitted through a carrier wave. There may be multiple storage devices 608 in the computing system 602. The input/output devices 612 may include a keyboard, mouse, pen, voice input device, touch input device, display, speakers, printers, etc., and any combination thereof.

The memory 610 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. The memory 610 may also include one or more external storage devices or remotely located storage devices that do not pertain to propagated signals, such as modulated data signals transmitted through a carrier wave.

The memory 610 may contain instructions, components, and data. A component is a software program that performs a specific function and is otherwise known as a module, program, engine, and/or application. The memory 610 may include an operating system 614, an encoder 616 (e.g. comprising encoder 110), a decoder 618 (e.g. comprising decoder 120), a discriminator 619 (e.g. comprising contraband discriminator 130), training data 620 (e.g. one or more plant images and/or ground-truth structural representations), trained parameters 622 (e.g. comprising parameters 112, 122, and/or 132), one or more input images 624 (e.g. plant images), and other applications and data 630. Depending on the embodiment, some such elements may be wholly or partially omitted. For example, an embodiment intended for inference (e.g. via system 300 and/or method 500) and which has trained parameters 622 might omit training data 620, decoder 618, discriminator 619, and/or some or all trained parameters 622 other than those required by encoder 616. As another example, memory 610 may include no images 624 prior to starting inference (e.g. via system 300 and/or method 500) and may receive images (one-by-one and/or in batches) via an input device 612 and/or from a storage device 608.

### Example Results

An example implementation of system 100 of FIG. 1 was trained according to method 400 using a dataset of 15000 unlabelled images of brassica spp., observed overhead from seedling to preflowering life stages. The contraband discriminator was trained over 100 ground-truth structural representations comprising manual sketches representing a distribution of interpretable, legal plant skeletons, and was also trained over skeletons predicted from unlabelled plant images as described previously. The manual sketches were prepared by hand, without input from the model, and are thus known to not contain smuggled texture information. The encoder and its trained parameters were then used for inference as an example system 300 according to method 500. The encoder was provided plant images from a held-back validation dataset (i.e. images not seen by the encoder or other parts of the system during training) and generated predicted skeletons, which were then compared to ground-truth skeletons prepared for the plant images in the validation set. (Such labelling was performed for the purpose of validation and is not necessarily required for the operation of systems 100 or 300.) The predicted and ground-truth skeletons were also compared to predicted skeletons produced by a classical skeletonization technique, which comprised binary segmentation of each image (i.e. labelling each pixel of the plant image as plant or background) and performing medial axis transformation to yield a predicted skeleton.

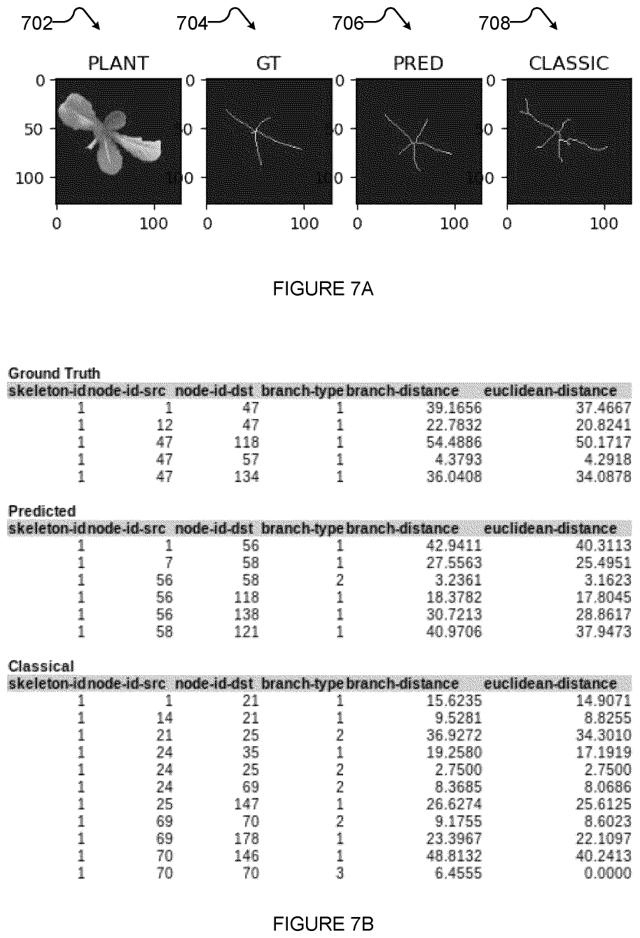

An example set of results is shown in FIG. 7A. Plant image 702 has a corresponding ground-truth skeleton 704, with each leaf of the plant in image 702 corresponding to a branch in skeleton 704. There are five branches in ground-truth skeleton 704. The encoder generated predicted skeleton 706, which identifies six branches. In predicted skeleton 706, one of the branches is a junction-junction branch; this is a short branch in the center of the image to which several other branches are attached, rather than all branches attaching to a single central point. The other five branches are all tip-junction branches, similar to the ground-truth skeleton's five branches. Finally, classic skeleton 708 was produced by classical techniques and identifies 11 branches. Qualitatively, classic skeleton 708 diverges significantly from ground-truth skeleton 704, whereas predicted skeleton 706 is relatively more similar to ground-truth skeleton 704 in terms of plant morphology.

The branches of each skeleton of FIG. 7A are described in the table of FIG. 7B. The first three columns can be ignored. “branch-type” is 0 for tip-tip branches, 1 for tip-junction branches (which is the type generally expected for this plant's morphology), 2 for junction-junction branches, and 3 for path-path branches. “branch-distance” indicates the length of the branch along its curve, and “euclidean-distance” indicates the distance between the endpoints of the branch. These values are generated by SKAN and are described in greater detail by Nunez-Iglesias (cited above).

Predicted skeletons and classical skeletons were generated as described above for each plant image in a validation set. Mean error in branch count (i.e. number of branches) and branch length for each predicted skeleton and classical skeleton relative to the relevant ground-truth skeleton was calculated as a metric for model accuracy. Predictions by the encoder outperformed classically-generated skeletons across the validation set, as shown below:

| Metric | Error |
|---|---|
| Branch count mean error | 0.8979 |
| (predicted vs ground truth) | |
| Branch count mean error | 2.3265 |
| (classic vs ground truth) | |
| Branch length mean error | 15.7957 |
| (predicted vs ground truth) | |
| Branch length mean error | 17.7797 |
| (classic vs ground truth) | |

Although the presently described machine learning model does not necessarily need to count leaves, this value may be derived from its structural representations in at least some embodiments. A mean error of ˜0.9 on branch counting (i.e. leaf counting, in the context of lettuce and many other plants) can be compared favourably to the current state-of-the-art result for leaf-counting machine learning models, which average an error of 1.118 as described by Giuffrida et al., Proceedings of the IEEE CVF Conference on Computer Vision and Pattern Recognition (CVPR) Workshops, 2019, pp. 0-0. This suggests that, in suitable circumstances, the presently-described systems and methods can provide advantages in the representation of plant structure.

### Extending to Non-Plant Objects

The present disclosure is not limited to plants. In some embodiments, system 100 trains encoder 110 (and, optionally, decoder 120 and/or other elements of the machine learning model of system 100) over images of non-plant objects, such as humans, animals, articles of manufacture, and/or other objects. Contraband discriminator 130 is trained on a set of ground-truth structural representations of the objects in question, such as wireframe images of human (and/or animal) skeletons, traces of objects (e.g. handbags, vehicles, and/or other articles), and/or other structural representations omitting some or all texture information, e.g. substantially as described with reference to FIGS. 2A and 2B. A potential advantage of contraband discriminator 130, and relating to the technical challenge of addressing many distinct forms of plant morphologies, is that it is applicable to at least some contexts where the objects in question are morphologically quite different than plants, so long as sufficient training data is available to train contraband discriminator 130. Encoder 110, when trained over images of such non-plant objects and with reference to such a contraband discriminator 130, may be used to perform inference over images of such non-plant objects substantially as described with reference to system 300 and method 500. Encoder 110 may be trained over both plant images and non-plant images (or over only plant images, or over only non-plant images) without deviating from the spirit and scope of the present disclosure.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A method for training a machine learning model for generating a structural representation of a plant, the method performed by a processor and comprising:
transforming, by an encoder, an input plant image to a predicted structural representation based on parameters of the encoder, the input plant image one of a plurality of plant images, each plant image representing a plant having a plurality of connected plant structures, and the predicted structural representation representing predicted connections between the plant structures of the input plant image;
transforming, by a decoder, the predicted structural representation to a reconstructed plant image based on parameters of the decoder;
classifying, by a discriminator, the reconstructed plant image as having been generated based on one of: the ground truth training dataset or parameters of the encoder to generate a classification based on parameters of the discriminator; and
training parameters of the encoder based on the classification.

2. The method according to claim 1 comprising training the discriminator by:
transforming, by the decoder, a ground-truth structural representation from a ground truth training dataset of predetermined structural representations to a second reconstructed plant image;
transforming, by the decoder, a second predicted structural representation to a third reconstructed plant image based on parameters of the decoder, the second predicted structural representation generated by the encoder based on parameters of the encoder;
classifying, by the discriminator, each of the second and third reconstructed plant images as having been generated based on one of: the ground truth training dataset or parameters of the encoder to generate respective second and third classifications based on parameters of the discriminator; and
training parameters of the discriminator based on the second and third classifications.

3. The method according to claim 1 wherein transforming the predicted structural representation to the reconstructed plant image comprises transforming the predicted structural representation to the first reconstructed plant image based on a texture representation separate from the predicted structural representation.

4. The method according to claim 3 comprising transforming, by a texture encoder, the input plant image to the texture representation, the texture representation comprising a relatively lower-dimensional encoding than the input plant image.

5. The method according to claim 4 comprising training parameters of the texture encoder based on the input plant image, the reconstructed plant image, and the classification.

6. The method according to claim 1 wherein training parameters of the encoder comprises training parameters of the encoder based on the input plant image and the reconstructed plant image.

7. The method according to claim 6 wherein training the parameters of the encoder comprises determining a value of an objective function based on a difference between the input plant image and the reconstructed plant image; determining a gradient of the objective function relative to parameters of the encoder based on the difference; and updating parameters of the encoder based on the gradient.

8. The method according to claim 6 wherein training parameters of the encoder comprises semisupervised training of parameters of the encoder, the semisupervised training comprising:
transforming a first number of the plurality of plant images to a plurality of predicted plant structural representations by the encoder;
transforming a second number of ground-truth structural representations from the ground truth training dataset to a plurality of reconstructed plant images by the decoder, the first number greater than the second number; and
training the parameters of the encoder based on the plurality of reconstructed plant images and the plurality of plant images.

9. The method according to claim 8 wherein the ground truth training dataset comprises at most a number of ground-truth structural representations no greater than: 1%, 2%, 3%, 4%, 5%, 10%, 20%, 30%, 40%, 50%, 60%, 70%, 80%, or 90% of a number of plant images of the plurality of plant images.

10. The method according to claim 9 wherein the ground-truth structural representations of the ground-truth training dataset represent a plurality of plants other than the plants represented by the plurality of plant images.

11. The method according to claim 1 wherein training parameters of the encoder comprises, for each of the predicted connections of the predicted structural representation, determining a plant morphology of the predicted connection and training the encoder based on the plant morphology.

12. The method according to claim 11 wherein determining the plant morphology comprises determining a branching characteristic, the branching characteristic comprising at least one of: number of branches, branch length, average branch length, branch type, branch curvature, and/or branch endpoint location.

13. The method according to claim 12 wherein the branching characteristic comprises branch type and determining the branching characteristic comprises determining, for at least one predicted connection, that the at least one predicted connection comprises a branch type of: tip-tip, tip-junction, junction-junction, path-path.

14. The method according to claim 13 wherein training parameters of the encoder comprises training parameters of the encoder to incentivize tip-junction branch types relative to one or more of tip-tip, junction-junction, and path-path branch types.

15. The method according to claim 12 wherein training parameters of the encoder comprises halting training based on the plant morphology.

16. The method according to claim 12 wherein training parameters of the encoder comprises determining a value of an objective function based on the plant morphology and training parameters of the encoder based on the value of the objective function.

17. The method according to claim 11 wherein the plant morphology comprises connectivity of the predicted connections, the method comprises determining a value of an objective function based on a shape prior representing connectivity of the predicted connections, and training parameters of the encoder comprises training parameters of the encoder based on the value of the objective function.

18. The method according to claim 17 wherein the method comprises transforming the predicted structural representation to a polar predicted structural representation having polar coordinates and determining the value of the objective function comprises determining a difference between the polar predicted structural representation and the shape prior in a polar domain.

19. The method according to claim 18 wherein transforming the predicted structural representation to the polar predicted structural representation comprises determining a center point of the predicted structural representation and transforming the predicted structural representation to the polar predicted structural representation based on the center point.

20. The method according to claim 19 wherein determining the center point of the predicted structural representation comprises determining a center point of the input plant image and identifying a corresponding point in the predicted structural representation as the center point of the predicted structural representation.

21. The method according to claim 1 wherein training parameters of the encoder comprises determining a value of an objective function based on one or more structural classifications generated by classifying the predicted structural representation, by one or more structure discriminators, as having been drawn from the ground truth training dataset or generated by the encoder, the value of the objective function based on the one or more structural classifications.

22. The method according to claim 21 wherein the one or more structure discriminators comprises a cartesian structure discriminator and classifying the predicted structural representation comprises generating a cartesian classification based on an image of the predicted structural representation comprising cartesian coordinates.

23. The method according to claim 21 wherein the one or more structure discriminators comprises a polar structure discriminator and classifying the predicted structural representation comprises generating a polar classification based on an image of the predicted structural representation comprising polar coordinates.

24. The method according to claim 23 comprising determining a center point of a cartesian predicted structural representation and transforming the cartesian predicted structural representation to the predicted structural representation comprising polar coordinates.

25. The method according to claim 24 wherein determining the center point of the cartesian predicted structural representation comprises determining a center point of the input plant image and identifying a corresponding point in the cartesian predicted structural representation as the center point of the cartesian predicted structural representation.

26. The method according to claim 1 wherein training parameters of the encoder comprises determining a value of an objective function based on one or more reconstruction classifications generated by classifying the reconstructed plant image, by one or more reconstruction discriminators, as having been generated by the decoder or drawn from the plurality of plant images, the value of the objective function based on the one or more reconstruction classifications.

27. The method according to claim 26 wherein the one or more reconstruction discriminators comprises a first reconstruction discriminator and classifying the reconstructed plant representation by the first reconstruction discriminator comprises classifying the reconstructed plant image as having been generated by the decoder based on a ground-truth structural representation from the ground-truth training dataset or drawn from the plurality of plant images.

28. The method according to claim 27 wherein the one or more reconstruction discriminators comprises a first reconstruction discriminator and classifying the reconstructed plant representation by the first reconstruction discriminator comprises classifying the reconstructed plant image as having been generated by the decoder based on the predicted structural representation generated by the encoder or drawn from the plurality of plant images.

29. A method for generating a structural representation of a plant by a machine learning model, the method performed by a processor and comprising:
transforming, by an encoder, an input plant image to a predicted structural representation based on parameters of the encoder, the parameters of the encoder trained according to claim 1.

30. A method for training a machine learning model for generating a structural representation for an object, the method performed by a processor and comprising:
transforming, by an encoder, an input image depicting the object to a predicted structural representation based on parameters of the encoder, the input image one of a plurality of images, each image representing an object having a structure and a texture, and the predicted structural representation representing the structure of the object;
transforming, by a decoder, the predicted structural representation to a reconstructed image based on parameters of the decoder;
classifying, by a discriminator, the reconstructed image as having been generated based on one of: a ground truth training dataset or parameters of the encoder to generate a classification based on parameters of the discriminator; and
training parameters of the encoder based on the classification.

31. The method according to claim 30 comprising training the discriminator by:
transforming, by the decoder, a ground-truth structural representation from a ground truth training dataset of predetermined structural representations to a second reconstructed image;
transforming, by the decoder, a second predicted structural representation to a third reconstructed plant image based on parameters of the decoder, the second predicted structural representation generated by the encoder based on parameters of the encoder;
classifying, by the discriminator, each of the second and third reconstructed images as having been generated based on one of: the ground truth training dataset or parameters of the encoder to generate respective second and third classifications based on parameters of the discriminator; and
training parameters of the discriminator based on the second and third classifications.

32. The method according to claim 30 wherein transforming the predicted structural representation to the reconstructed image comprises transforming the predicted structural representation to the first reconstructed image based on a texture representation separate from the predicted structural representation.

33. The method according to claim 32 comprising transforming, by a texture encoder, the input image to the texture representation, the texture representation comprising a relatively lower-dimensional encoding than the input image.

34. The method according to claim 33 comprising training parameters of the texture encoder based on the input image, the reconstructed image, and the classification.

35. The method according to claim 30 wherein training parameters of the encoder comprises training parameters of the encoder based on the input image and the reconstructed image.

36. The method according to claim 35 wherein training the parameters of the encoder comprises determining a value of an objective function based on a difference between the input image and the reconstructed image; determining a gradient of the objective function relative to parameters of the encoder based on the difference; and updating parameters of the encoder based on the gradient.

37. The method according to claim 35 wherein training parameters of the encoder comprises semisupervised training of parameters of the encoder, the semisupervised training comprising:
transforming a first number of the plurality of images to a plurality of predicted object structural representations by the encoder;
transforming a second number of ground-truth structural representations from the ground truth training dataset to a plurality of reconstructed images by the decoder, the first number greater than the second number; and
training the parameters of the encoder based on the plurality of reconstructed images and the plurality of images.

38. The method according to claim 37 wherein the ground truth training dataset comprises at most a number of ground-truth structural representations no greater than: 1%, 2%, 3%, 4%, 5%, 10%, 20%, 30%, 40%, 50%, 60%, 70%, 80%, or 90% of a number of images of the plurality of images.

39. The method according to claim 38 wherein the ground-truth structural representations of the ground-truth training dataset represent a plurality of objects other than the objects represented by the plurality of images.

40. The method according to claim 30 wherein training parameters of the encoder comprises determining a value of an objective function based on one or more structural classifications generated by classifying the predicted structural representation, by one or more structure discriminators, as having been drawn from the ground truth training dataset or generated by the encoder, the value of the objective function based on the one or more structural classifications.

41. The method according to claim 40 wherein the one or more structure discriminators comprises a cartesian structure discriminator and classifying the predicted structural representation comprises generating a cartesian classification based on an image of the predicted structural representation comprising cartesian coordinates.

42. The method according to claim 40 wherein the one or more structure discriminators comprises a polar structure discriminator and classifying the predicted structural representation comprises generating a polar classification based on an image of the predicted structural representation comprising polar coordinates.

43. The method according to claim 42 comprising determining a center point of a cartesian predicted structural representation and transforming the cartesian predicted structural representation to the predicted structural representation comprising polar coordinates.

44. The method according to claim 43 wherein determining the center point of the cartesian predicted structural representation comprises determining a center point of the input image and identifying a corresponding point in the cartesian predicted structural representation as the center point of the cartesian predicted structural representation.

45. The method according to claim 30 wherein training parameters of the encoder comprises determining a value of an objective function based on one or more reconstruction classifications generated by classifying the reconstructed image, by one or more reconstruction discriminators, as having been generated by the decoder or drawn from the plurality of images, the value of the objective function based on the one or more reconstruction classifications.

46. The method according to claim 45 wherein the one or more reconstruction discriminators comprises a first reconstruction discriminator and classifying the reconstructed object representation by the first reconstruction discriminator comprises classifying the reconstructed image as having been generated by the decoder based on a ground-truth structural representation from the ground-truth training dataset or drawn from the plurality of images.

47. The method according to claim 46 wherein the one or more reconstruction discriminators comprises a first reconstruction discriminator and classifying the reconstructed object representation by the first reconstruction discriminator comprises classifying the reconstructed image as having been generated by the decoder based on the predicted structural representation generated by the encoder or drawn from the plurality of images.

48. A method for generating a structural representation for an object by a machine learning model, the method performed by a processor and comprising:
transforming, by an encoder, an input image to a predicted structural representation based on parameters of the encoder, the parameters of the encoder trained according to claim 1.

49. A computer system comprising:
one or more processors; and
a memory storing instructions which cause the one or more processors to perform operations comprising the method of claim 1.
